(19) United States
(12) Patent Application Publication
(10) Pub. No.: US 2025/0169387 A1
(43) Pub. Date: May 29, 2025

(54) CONNECTION SYSTEM

(71) Applicants: KRONE AGRICULTURE SE, SPELLE (DE); LEMKEN GMBH & CO. KG, ALPEN (DE)

(72) Inventors: HANNES MAEHLMANN-DUNKER, NEUENKIRCHEN (DE); STEFAN MAESING, BORKEN (DE)

(73) Assignees: KRONE AGRICULTURE SE, SPELLE (DE); LEMKEN GMBH & CO. KG, ALPEN (DE)

(21) Appl. No.: 18/938,312

(22) Filed: Nov. 6, 2024

(30) Foreign Application Priority Data
Nov. 9, 2023 (DE) 10 2023 131 191.3

(51) Int. Cl. A01B 59/042; B60D 1/14; B60D 1/145

(52) U.S. Cl. CPC A01B 59/042; B60D 1/143; B60D 1/145

(57) ABSTRACT

A connection system for connecting an agricultural machine to a towing vehicle. The connection system includes a drawbar unit and at least one coupling element. The drawbar unit has a support part for support on the towing vehicle and a drawbar boom. The drawbar boom is connected at least indirectly to the support part and swivels relative to the support part about a front drawbar axis. The at least one coupling element is arranged on the drawbar boom and at least indirectly couples to the agricultural machine.

### CROSS REFERENCE TO PRIOR APPLICATIONS

Priority is claimed to German Patent Application No. DE 10 2023 131 191.3, filed Nov. 9, 2023. The entire disclosure of said application is incorporated by reference herein.

### FIELD

The present invention relates to a connection system and to a method therefor.

### BACKGROUND

Agricultural machinery that is pulled by a tractor during field processing and self-propelled agricultural machinery that is controlled by a driver during field processing have long since been known. These machines can also be moved in the same way during transfer journeys or road travel, i.e., on the way to or from the field, either pulled by the tractor or steered by the driver. The brake is supplied with power and controlled from the towing vehicle on towed agricultural machinery. This also applies to steerable axes of the towed agricultural machine if available. Autonomous agricultural machines are also increasingly being used which have their own drive and steering and which perform field processing independently without control commands from an operator. Because these vehicles cannot autonomously perform a transfer journey on the road, they must be loaded, for example, onto a low-loader. This is time-consuming and increases the costs for the entire operation.

One possible alternative is to attach the agricultural machine to a towing vehicle for a transfer journey, similar to a trailer. The agricultural machine could, for example, be coupled to the towing vehicle via a drawbar, whereby any change in the position of the towing vehicle relative to the agricultural machine influences the drawbar angle or articulation angle of the drawbar, which could be detected by sensors and used for steering the agricultural machine. At least one axis could also be steered mechanically by the drawbar. However, a drawbar that remains permanently attached to the agricultural machine is a considerable hindrance if working in the field because it is inevitably positioned in an area that would be suitable for a working implement such as a plow, harrow, mower unit, etc. It would also be possible to use a drawbar that can be coupled to both the towing vehicle and the agricultural machine so that it can swivel freely and be removed again after road travel. The drawbar must be removed and stowed away at the end of the road travel, which means increased effort. The same applies to reassembly for the next road travel. The tie rod also transmits tensile and compressive forces, but no torque, so it cannot be used, for example, for forced steering.

### SUMMARY

An aspect of the present invention is to provide an improved system with which an agricultural machine can be temporarily coupled to a towing vehicle for road travel.

In an embodiment, the present invention provides a connection system for connecting an agricultural machine to a towing vehicle. The connection system includes a drawbar unit and at least one coupling element. The drawbar unit comprises a support part for support on the towing vehicle and a drawbar boom. The drawbar boom is connected at least indirectly to the support part and is configured to swivel relative to the support part about a front drawbar axis. The at least one coupling element is arranged on the drawbar boom and is configured to at least indirectly couple to the agricultural machine.

### BRIEF DESCRIPTION OF THE DRAWINGS

The present invention is described in greater detail below on the basis of embodiments and of the drawings in which:

FIG. 1 shows a bottom view of an agricultural machine with parts of a connection system according to the present invention in a first state;

FIG. 2 shows a bottom view of an agricultural machine according to the present invention with parts of a connection system in a second state;

FIG. 3 shows a diagram of a transmission device of the agricultural machine from FIG. 1 in a deceleration steering mode;

FIG. 4 shows a diagram of the transmission device from FIG. 3 in a single steering mode;

FIG. 5 shows a side view of a part of the agricultural machine from FIG. 1, a towing vehicle, and the connection system;

FIG. 6 shows a detailed perspective view of the connection system from FIG. 5;

FIG. 7 shows a detailed perspective view of the connection system from FIG. 5 in a first state; and

FIG. 8 shows a detailed perspective view of the connection system from FIG. 5 in a second state.

### DETAILED DESCRIPTION

The present invention provides a connection system for connecting an agricultural machine to a towing vehicle, the connection system having a drawbar unit which has a support part for supporting the towing vehicle and a drawbar boom which is connected at least indirectly to the support part and can swivel relative to the latter about a front drawbar axis, at least one coupling element being arranged on the drawbar boom for at least indirect coupling to the agricultural machine.

The agricultural machine can also be referred to as an agricultural work machine. It can in particular be a harvesting machine such as a forage harvester, a combine harvester, a baler or a loader wagon. It could also be, for example, a tedder, a plough, a fertilizer spreader, a slurry tanker or similar. The agricultural machine is set up for field processing, for example, for ploughing, fertilizing, mowing, tedding, picking up crops or the like. The agricultural machine can be set up for coupling various attachments, such as a plow, a tedder, a cutting unit or similar. The actual vehicle body of the agricultural machine may, under certain circumstances, not be set up for any specific field processing. It can, however, have coupling structures such as a three-point hoist which can be used to couple an attachment adapted to the respective field processing. The agricultural machine is therefore also set up for field processing in this case. The agricultural machine can be a trailer which is pulled by a tractor during field processing. The agricultural machine can, however, for example, have its own power drive, which drives it during field processing. The agricultural machine can, for example, in particular be designed as an autonomous vehicle which is set up to carry out field processing without control commands from a driver or operator. It is also conceivable, however, for the agricultural machine to have a control stand or a driver's cab and be controlled by a driver if required.

The towing vehicle itself can be an agricultural machine, however, it can also be another vehicle, for example, a truck. The towing vehicle is normally a motor vehicle with its own power drive, however, it could also be, for example, a trailer without its own drive that is towed in turn. It can be a vehicle that is driven by a driver or an autonomous vehicle.

The agricultural machine and/or the towing vehicle can be considered part of the connection system in whole or in part. At least the towing vehicle, for example, is not, however, regarded as part of the connection system.

The connection system is designed to connect the agricultural machine to the towing vehicle. A temporary connection is in particular provided for road travel. The connection can, for example, at least be designed to transmit tractive and compressive forces between the towing vehicle and the agricultural machine. Transverse forces and/or torques can optionally also be transmitted.

The support part is designed to support the towing vehicle. It can also be said that the support part is designed for coupling to the towing vehicle, whereby the term “support” implies that the support part can transfer at least a predominant part of the weight force acting on the drawbar unit to the towing vehicle, for example, the entire weight force. The support part can, for example, be connected to the towing vehicle so that torques acting on the drawbar unit are absorbed by the towing vehicle. Such torques therefore do not cause the support part to swivel or tilt. To achieve this, the support part can, for example, be designed to be connected to the towing vehicle at a plurality of points. A connection to a lifting mechanism of the towing vehicle can in particular be provided, for example, with a three-point hoist. The support part can, for example, be rigid in itself, but could also consist of a plurality of rigidly connected individual elements.

The drawbar boom is at least indirectly connected to the support part. This means that it is either connected directly to the support part or via at least one other intermediate element. The drawbar boom can be swiveled around a front drawbar axis relative to the support part. The front drawbar axis can, for example, run at least predominantly vertically, for example, at an angle of less than 20° to the direction of gravity or to a vertical axis of the towing vehicle, in relation to the intended coupled state of the drawbar unit. The term “front drawbar axis” should not be interpreted to mean that the connection system must necessarily have a rear drawbar axis. Due to the swivel capability, the drawbar boom can be aligned in various horizontal directions relative to the support part and the towing vehicle. The drawbar boom can be at least predominantly straight. It can, for example, be elongated, i.e., has a dimension (“length”) that can be at least twice, at least five times, or at least ten times, larger than the other dimensions (“width”, “height”). The drawbar boom can, for example, itself be rigid. The drawbar boom is in particular designed to transmit tractive and compressive forces between the towing vehicle and the agricultural machine.

At least one coupling element is arranged on the drawbar boom for at least an indirect coupling to the agricultural machine. The coupling element can be part of the drawbar boom or connected thereto. The connection can be rigid or movable. The at least one coupling element is designed to at least indirectly couple the drawbar boom, and thus the drawbar unit and the towing vehicle, to the agricultural machine. The coupling can, for example, be based at least partially on a positive fit. It can be provided directly with the agricultural machine or with an intermediate element, which is in turn coupled to the agricultural machine.

The connection system according to the present invention thus enables a connection system similar to a drawbar permanently connected to the agricultural machine during road travel. No drawbar is, however, required on the agricultural machine side because the connection is at least partially established by the swiveling drawbar boom. At least part of the connection system can be disconnected from the agricultural machine for field processing and can remain on the towing vehicle. The drawbar unit is still coupled and supported there via the support part so that it need not be removed and stowed away. The disadvantages associated with a drawbar permanently attached to the agricultural machine, in particular for the use of a field processing device, are thus avoided in the connection system according to the present invention, as are the disadvantages of a removable drawbar.

The connection system can, for example, have a drawbar element which is set up for an at least indirect connection to a frame of the agricultural machine which can be swiveled about a rear drawbar axis, wherein coupling elements which correspond to one another are arranged on the drawbar boom and on the drawbar element, which are arranged to couple the drawbar boom and the drawbar element at least translationally in a locking position if these are arranged in a coupling position relative to one another, at least one coupling element being adjustable into a release position in order to release the drawbar boom from the drawbar element.

The drawbar element is designed for an at least indirect connection to a frame of the agricultural machine that can be swiveled around a rear drawbar axis. Such a frame is generally rigid and can consist of a number of rigidly connected individual elements. The frame forms a mechanically stable base on which other components of the agricultural machine can be arranged. At least one front axis and one rear axis can in particular be arranged on the frame. Both axes can be steered in the case of an autonomous agricultural machine. The drawbar element can have a swivel bearing or at least a receptacle for a swivel bearing via which the swivel capability in relation to the frame is provided. When mounted, it can be connected directly to the frame or to an intermediate element (e.g., the front axis), which in turn is connected to the frame. This also includes the possibility that the drawbar element is rigidly connected to the intermediate element, while the intermediate element is connected to the frame in a swiveling manner. In this case, however, both elements can also be together considered as a “drawbar element” in the sense of this embodiment. Like the front drawbar axis, the rear drawbar axis can also, for example, run at least predominantly vertically, for example, at an angle of less than 20° to the direction in which gravity acts or to a vertical axis of the agricultural machine, relative to the state of the drawbar element connected to the frame. The drawbar element can, for example, be permanently connected to the frame, either directly or indirectly. The frame of the agricultural machine or the agricultural machine as a whole can be regarded as part of the connection system. It can also be said in this case that the drawbar element is connected to the frame of the agricultural machine so that it can swivel around the rear drawbar axis. The drawbar element can in particular be swiveled around the rear drawbar axis on the frame. The drawbar element can, for example, itself be rigid. The drawbar element is also designed to transmit tractive and compressive forces between the towing vehicle and the agricultural machine. Although there are no fundamental restrictions in this respect, the drawbar element can be significantly shorter than the drawbar boom. A largest dimension of the drawbar element can, for example, correspond to at most 50% or at most 30% of a largest dimension of the drawbar boom.

Corresponding coupling elements are arranged on the drawbar boom and on the drawbar element which are designed to couple the drawbar boom and the drawbar element at least translationally in a locking position if they are arranged in a coupling position relative to one another, at least one coupling element being adjustable into a release position in order to release the drawbar boom from the drawbar element. At least one coupling element is arranged on the drawbar boom and at least one corresponding coupling element is arranged on the drawbar element. “Corresponding” means that these coupling elements are set up to interact with each other. The interaction serves to couple the drawbar boom and the drawbar element to each other. More precisely, these are coupled translationally if they are arranged in a coupling position relative to each other and if the coupling elements are in a locking position. In the translationally coupled state, translational relative movements between the drawbar boom and the drawbar element are at most possible to a limited extent, which applies to all three dimensions. The drawbar boom and the drawbar element can in particular be locked against each other translationally so that no significant relative movements between the drawbar boom and the drawbar element are possible. The term “locking position” is not to be interpreted restrictively, for example, to translational locking. Even if there are no translational degrees of freedom, there may be at least a rotational degree of freedom, in particular exactly one rotational degree of freedom. There can, for example, be at least a partial rotational locking, i.e., the number of rotational degrees of freedom is reduced to a maximum of two degrees of freedom. The drawbar boom and drawbar element can be swiveled relative to each other about a swivel axis of the coupling, which can be defined by the coupling elements. The coupling elements can be designed so that they do not form a tangential form fit with respect to the swivel axis of the coupling in the locking position. The swivel axis of the coupling can, for example, be at least partially horizontal. If a rotational degree of freedom is missing, the drawbar boom and drawbar element behave like a single rigid body. Even if the degree of rotational freedom is given, they together form a drawbar, so to speak, which connects the towing vehicle to the agricultural machine. This drawbar can be swiveled around the front drawbar axis and the rear drawbar axis. This makes relative movements within the horizontal plane possible. Relative movements in a vertical direction are also possible if the swivel axis of the coupling is at least partially horizontal. It is understood that the drawbar boom extends at least predominantly horizontally, at least if coupled. The same applies to the drawbar consisting of the drawbar boom and the drawbar element.

At least one coupling element can be moved into a release position in order to detach the drawbar boom from the drawbar element. The corresponding coupling element can therefore be adjusted, for example, swiveled and/or moved, between the locking position and the release position. The connection between the drawbar boom and the drawbar element is therefore not permanent but can be disconnected again if necessary. This can be performed in particular with an autonomous agricultural machine after the end of road travel. After the end of road travel, a part, for example, the larger part, of the connection system is separated from the agricultural machine and can remain on the towing vehicle. This part, namely the drawbar unit, is still coupled and supported there via the support part so that it need not be removed and stowed away. Another part, for example, the smaller part, can remain on the agricultural machine. The corresponding drawbar element can be designed to be so small that it does not, for example, interfere with the use of a field processing device. A torque could nevertheless be transmitted via a swivel-mounted drawbar element on the frame, making it possible, for example, to realize a forced steering of an axis. The drawbar element can be mechanically connected to an element of the axis, for example, via a tie rod to a steering knuckle.

An embodiment of the present invention provides that at least one first stop coupling element is rigidly connected to the drawbar element and at least one second stop coupling element is rigidly connected to the drawbar boom and forms a positive fit with the at least one first coupling element in the coupling position, wherein at least one actuating coupling element is adjustable between the locking position and the release position. This means that at least one coupling element is rigidly connected to both the drawbar element and the drawbar boom, which is referred to as a (first or second) stop coupling element. The positive fit between the stop coupling elements can define the coupling position on at least one side, i.e., it can prevent movement beyond the coupling position. The positive locking is not complete, i.e., a relative movement is possible as long as the actuating coupling element is not moved into the locking position. According to an embodiment, the tractive force between the towing vehicle and the agricultural machine can, for example, be transmitted at least partially via the stop coupling elements.

One possibility is that an actuating coupling element is connected to the drawbar element. It can be advantageous to keep the structure of the agricultural machine simple in the area of the drawbar element and not to provide a moving part there. An embodiment of the present invention provides that at least one actuating coupling element is adjustably connected to the drawbar boom and, in the locking position, at least one first stop coupling element is positively received between an actuating coupling element and a second stop coupling element. The adjustable actuating coupling element is therefore assigned to the drawbar unit, which means that the structure remains simple in the area of the drawbar element. Remote control of the actuating coupling element, which will be discussed below, can also be provided more easily on the drawbar boom than on the drawbar element. The actuating coupling element can in particular be connected to the drawbar boom in a swiveled manner, although translational adjustability would also be conceivable, for example, in the manner of a slider. When the actuating coupling element has reached the locking position, it positively engages the second stop coupling element together with a first stop coupling element, as a result of which it can, for example, be at least translationally locked. The second stop coupling element can be in contact with both the actuating coupling element and the first stop coupling element.

In an embodiment of the present invention, the drawbar boom and the drawbar element can, for example, be guided into the coupling position in an at least partially horizontal coupling direction, with the stop coupling elements forming a positive fit in the coupling position at least in the coupling direction. The coupling device can be defined as the direction of movement of the drawbar boom relative to the drawbar element. In the corresponding coupling device, the two elements can move into the coupling position without colliding with each other. The movement into the coupling position in some embodiments can be at least partially guided. This means that interacting guide structures can be arranged on the drawbar boom and the drawbar element. In the coupling position, the first and second stop coupling elements form a positive fit with each other, which relates at least to the coupling device, i.e., they form a stop that prevents further movement in the coupling device. The coupling device runs at least partially horizontally and can in particular run at an angle of less than 20° to the horizontal plane. A tensile force can also be transmitted between the drawbar boom and the drawbar element via the positive locking of the stop coupling elements in some embodiments.

An embodiment of the present invention provides for the connection system to have stationary first guide surfaces relative to the drawbar element and stationary second guide surfaces relative to the drawbar boom, which define a clearance between them transverse to the coupling direction, at least one guide surface being beveled at least in some areas relative to the coupling direction so that the clearance is reduced as the coupling position is approached. The first guide surfaces can be formed on the drawbar element itself or on a stationary component connected thereto, for example, a first stop coupling element. The second guide surfaces can also be formed on the drawbar element itself or on a stationary component connected thereto, for example, a second stop coupling element. Due to their dimensions and/or their arrangement relative to each other, the guide surfaces define a clearance transverse to the coupling direction. This is the space for a possible relative movement between the drawbar boom and the drawbar element. If the guide surfaces are in contact with each other, the clearance is zero. If the drawbar boom and drawbar element are still away from the coupling position, it is advantageous if the clearance is of a certain size, which facilitates the coupling process in this phase. The clearance should be minimal at the latest if the coupling position is reached, i.e., almost zero, as the relative position of the drawbar element and drawbar boom should here be precisely defined. The clearance is gradually reduced in the direction of the coupling position via beveling at least one guide surface with respect to the coupling direction. This means that the elements involved are moved into the correct position. Pairs of guide surfaces can be provided that are arranged opposite each other like cheeks. A single guide surface could alternatively also be designed like a funnel, for example, in the shape of a cone.

A locking mechanism is advantageously arranged on the drawbar boom which has the at least one actuating coupling element and via which the at least one actuating coupling element can be remotely operated. This means that the locking mechanism has the actuating coupling element and additionally at least one element via which the remote control capability is provided. In the broadest sense, “remote-controllable” means that a user does not need direct access to the actuating coupling element. It can be a significant advantage in terms of user-friendliness if the user must access an area that is, for example, at least 1 m away from the actuating coupling element. Due to the distance gained, the user can also make the adjustment, for example, if an attachment is coupled to the agricultural machine that is arranged above the drawbar boom.

In an embodiment of the present invention, the locking mechanism can, for example, have a control lever which is arranged in a swiveling manner on the drawbar boom, which is arranged at a distance from the at least one actuating coupling element, and which is connected thereto in a force-transmitting manner, in particular via at least one coupling rod. By swiveling the control lever, the at least one actuating coupling element can be adjusted between the release position and the locking position, for example, also swiveled. The power transmission could in principle be hydraulic. Mechanical power transmission can, for example, be used for reasons of simplicity and robustness. At least one coupling rod can in particular be interposed between the control lever and the actuating coupling element. The at least one coupling rod can be swivel-mounted on both sides. The swivel axes involved form a quadrangle if the actuating coupling element can also be swiveled. If the distance between the swivel axes of the coupling rod differs from the distance between the swivel axes of the control lever and the actuating coupling element, it may only be possible to change between the locking position and the release position if the elements involved are elastically deformed. This can result in an unstable point between the aforementioned positions which can only be overcome by applying a corresponding torque to the control lever. The elastic deformation results in a restoring force so that the locking mechanism automatically returns to this position if there is a slight deflection from one of the positions. This allows the locking position to in particular be additionally secured.

In order to facilitate the coupling and uncoupling of the drawbar boom and drawbar element, the at least one actuating coupling element can, for example, be actuated via the locking mechanism. In other words, the locking mechanism has at least one actuator that enables the corresponding adjustment. The actuator, which can, for example, be designed as a hydraulic cylinder, can, for example, be controlled from the tractor. A corresponding actuator could act on one of the above-mentioned control levers, however, the locking mechanism could also be designed completely differently.

One possibility is that at least one actuating coupling element is designed as a latching element which is set up to be deflected elastically out of the locking position against a restoring force if approaching the coupling position and to return to the locking position following the restoring force if the coupling position is reached. The actuating coupling element can, for example, interact with a first stop coupling element and be deflected out of the locking position thereby. The shape of the two elements can be matched so that the deflection is terminated if the coupling position is reached, and the actuating coupling element returns to the locking position. This can be referred to as locking the actuating coupling element.

In various embodiments of the present invention, the drawbar boom protrudes horizontally from the towing vehicle if the drawbar unit is coupled thereto. As long as the connection to the drawbar element of the agricultural machine is established, the corresponding length of the drawbar boom is an advantage because this provides sufficient distance between the inside wheels of the towing vehicle and the agricultural machine if driving, for example, through tight bends. As soon as the agricultural machine is uncoupled, however, the protruding drawbar boom on the towing vehicle is a disadvantage, in particular with regard to possible participation in road traffic. The drawbar boom can then, for example, be swiveled about an at least partially horizontal mounting axis relative to the support part between a towing position and a mounting position, whereby it can, for example, be swiveled about the mounting axis by an actuator. The towing position is normally an at least approximately horizontal position and corresponds to a position in which the drawbar boom is or at least can be coupled to the drawbar element. The mounting position can in particular be an approximately vertical position. This means that swiveling between the towing position and the mounting position can take place at an angle of, for example, between 70° and 110°, in particular between 80° and 100°. When the drawbar boom is in the mounting position, the towing vehicle can, depending on the design, take part in road traffic without any problems. The mounting axis can, for example, run horizontally, for example, parallel to a transverse axis of the towing vehicle. Although a manual adjustment of the drawbar boom is conceivable, the drawbar boom can, for example, be swiveled by an actuator. This can be performed, for example, via a hydraulic cylinder that can be controlled from the towing vehicle.

The drawbar boom could be directly connected to the support part. However, this would make it more difficult to realize both swivel capability around the front drawbar axis and swivel capability around the mounting axis. In an embodiment, the drawbar unit can, for example, have a swivel part which is connected to the support part so that it can swivel about the front drawbar axis, to which the drawbar boom is connected so that it can swivel around the mounting axis. This means that the swivel part can be swiveled about the front drawbar axis together with the drawbar boom. The drawbar boom can also be swiveled about the mounting axis in relation to the swivel part and the support part. Their alignment in relation to the support part naturally depends on the current swivel position of the swivel part.

The drawbar boom can optionally be swiveled relative to the support part around a further swivel axis which, in at least some embodiments, can be referred to as a pendulum swivel axis or roll swivel axis. The swivel axis can, for example, run at an angle of 80° to 100°, in particular 90°, to the mounting axis. The swivel axis can also extend, for example, at an angle of between 70° and 100°, in particular 80° to 100°, to the horizontal plane, at least in the towing position of the drawbar boom. The aforementioned swivel axis can in particular run parallel to a longitudinal axis of the drawbar boom at least in the towing position. This additional swivel axis can compensate for rotational relative movements around the longitudinal axis of the towing vehicle and/or around the longitudinal axis of the agricultural machine. This can also be described as a rolling movement or movement around a rolling axis. In order to provide the swivel capability, the support part, the swivel part and/or the drawbar boom could be replaced by two parts that swivel against each other.

The drawbar boom should be able to swivel freely around the front drawbar axis in a normal driving operation. It can be useful for the coupling process if the drawbar boom can be held back in a central position relative to the front drawbar axis in relation to the support part. The center position can, for example, be a position in which the drawbar boom is aligned parallel to the longitudinal axis of the towing vehicle. “Retainable” can in particular mean “lockable”, but it can also refer to elastic retention. In the latter case, deflection from the center position is possible due to external torques, but against a restoring torque that limits the deflection and provides a return to the center position. The advantage of a corresponding locking device or elastic restraint is that the drawbar boom can be aligned by aligning the towing vehicle. This means that the steering and power drive of the towing vehicle provide at least a sufficiently precise way of moving the drawbar boom into a predetermined position, for example, into the coupling position. If the drawbar boom is connected to the support part via the above-mentioned swivel part, the swivel part in this embodiment can be restrained relative to the support part, resulting in the drawbar boom being restrained relative to the front swivel axis. The drawbar boom can, for example, be guided into the center position by an actuator and/or retained in the center position by an actuator. This means that at least one actuator is provided that guides the drawbar boom (or the swivel part including the drawbar boom) from a position that is swiveled sideways, for example, to the center position. An actuator can alternatively or additionally be set up to hold the drawbar boom back in the center position. This can be one and the same actuator. A locking actuator, for example, a hydraulic locking cylinder, can bring a locking element into a tangential form fit with a retaining structure. The locking actuator can be arranged on the drawbar boom or on the swivel part and the retaining structure on the support part. The reverse allocation would also be possible. The retaining structure could be formed by a curved track whose contour recedes radially to an area in which the locking element is arranged in the center position. If the locking element is pressed against the curved track, this results in a torque around the front drawbar axis which guides the drawbar boom into the center position.

The connection system can have at least one monitoring sensor which is set up to monitor an approach to the coupling position. This means that the monitoring sensor can be used to monitor whether and, if so, how the coupling position is approached. The data provided by the monitoring sensor can either be made available to a user, for example, the driver of the towing vehicle, or it could also be used by an autonomous system that performs the coupling process fully or partially automatically. A monitoring sensor can in particular be designed as a camera. The camera can be arranged on the drawbar unit, for example, on the support part or on the drawbar boom, but possibly also on the swivel part if available. An arrangement on the drawbar element is also conceivable. The monitoring sensor should in any case detect an area in which at least one coupling element is located during the coupling process. All of the coupling elements can be arranged in the area if directly approaching the coupling position. In the case of a camera, the detection of the area means that the area is in the camera's field of view.

The connection system can advantageously have at least one coupling sensor which is set up to determine if the locking position is reached and to send a locking signal to a machine control unit of the agricultural machine. Reaching the locking position indicates the successful completion of the coupling process if the coupling position has been reached. The coupling sensor can detect the locking position in various ways, including contactless if necessary. One possibility is that the coupling sensor is designed as a simple touch sensor or switch. It could be arranged on the first stop coupling element and activated by the actuating coupling element on contact. This would also provide that the coupling sensor is not triggered if the actuating coupling element assumes the locking position but the drawbar boom and the drawbar element are not in the coupling position. Various other arrangements for the coupling sensor are also possible. The coupling sensor can, for example, be connected to the machine control unit by wire. It could also be connected to a wireless interface that sends the locking signal wirelessly to an interface assigned to the machine control unit. The machine control unit of the agricultural machine can receive the locking signal and recognize therefrom that the agricultural machine is now coupled to the towing vehicle.

The machine control unit of the agricultural machine can react in different ways when the locking signal is received. The machine control unit can, for example, emit an acoustic, visual or other signal via a corresponding interface to inform the user of the successful coupling process. The machine control unit can also transmit information about the coupling process to the towing vehicle or to a mobile device via an interface. It may in particular be provided that the machine control unit is set up to switch to a mode intended for road travel if the locking signal is received. The machine control unit can make various settings on the agricultural machine for this purpose. It can, for example, switch to a deceleration steering mode in which a rear axis is deflected in the opposite direction to the front axis if an absolute amount of front axis deflection exceeds a threshold value. It can also switch to a mode in which the front axis is positively steered by the drawbar element. For field processing, on the other hand, the machine control unit can set a single steering mode in which both the front axis and the rear axis are steered individually. The machine control unit can control steering actuators that are assigned to the axes for individual steering.

The present invention also provides a method for connecting an agricultural machine to a towing vehicle, wherein a drawbar unit, which has a support part and a drawbar boom connected at least indirectly to the support part and swiveled relative to the latter about a front drawbar axis, is supported by the support part on the towing vehicle and wherein at least one coupling element is arranged on the drawbar boom, via which the drawbar boom is coupled at least indirectly to the agricultural machine. For coupling, the towing vehicle with the drawbar unit and the agricultural machine can approach each other until a coupling position is reached in which the drawbar boom is at least indirectly coupled to the agricultural machine.

The aforementioned terms have already been explained with reference to the connection system according to the present invention and will therefore not be explained again. Embodiments of the method according to the present invention correspond to those of the connection system according to the present invention.

A drawbar element can in particular be swiveled about a rear drawbar axis, at least indirectly connected to a frame of the agricultural machine, wherein coupling elements corresponding to one another are arranged on the drawbar boom and on the drawbar element, wherein the drawbar boom and the drawbar element are arranged in a coupling position and are coupled at least translationally via the coupling elements, for which purpose at least one coupling element is displaced from a release position for releasing the drawbar boom from the drawbar element into a locking position.

To uncouple the agricultural machine from the towing vehicle, at least one coupling element can be moved from the locking position to the release position, after which the drawbar unit and the drawbar element are moved out of the coupling position. The towing vehicle and/or the agricultural machine can be moved, in particular driven, for this purpose.

The present invention is described below with reference to drawings. The drawings are merely exemplary and do not limit the general idea of the present invention.

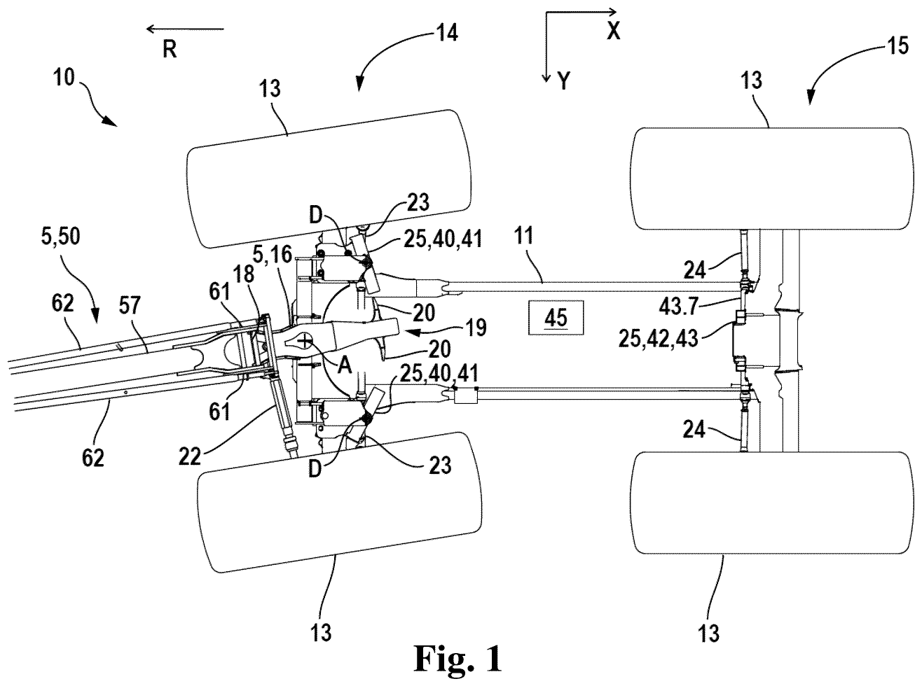

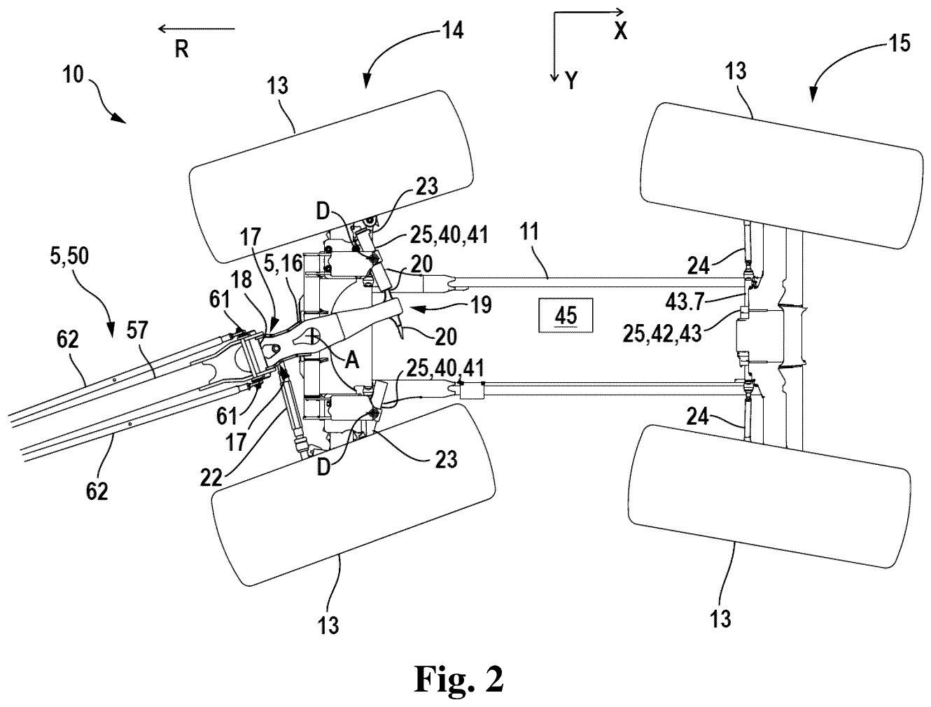

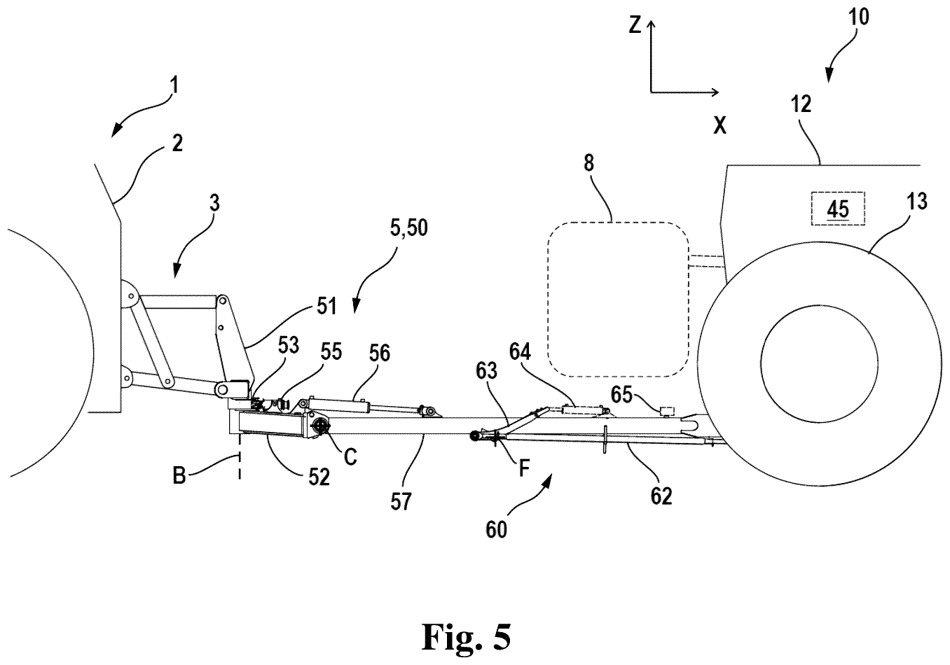

FIGS. 1 and 2 show views of an agricultural machine 10, which in this example is designed as an autonomous vehicle. A longitudinal axis X, a transverse axis Y, and a vertical axis Z of the agricultural machine 10 are shown here and in the following, as well as a direction of travel R pointing in the opposite direction to the longitudinal axis X. Various parts of the agricultural machine 10 have been omitted for simplification, in particular the majority of a vehicle body 12 (which is indicated in FIG. 5). A frame 11 is recognizable, on which a steerable front axis 14 and a likewise steerable rear axis 15 are arranged, which is arranged behind the front axis 14 with respect to the direction of travel R. Both axes 14, 15 each have two wheels 13 arranged next to each other in relation to the transverse axis Y. Each axis 14, 15 has Ackerman steering, whereby a steering knuckle of the respective wheel 13 (which is not visible in the figures) is steered via tie rods 23, 24. Tie rods 23 of the front axis 14 are coupled to a steering cylinder of the front axis 14 (not shown for reasons of clarity), while tie rods 24 of the rear axis 15 are coupled to a steering cylinder of the rear axis 43, more precisely to a piston rod of the steering cylinder 43.7 thereof. Both axes 14, 15 are operated in a single steering mode during field processing, whereby a machine control unit 45 can steer each of the axes 14, 15 independently of one another depending on the situation via the respective steering cylinders 43.

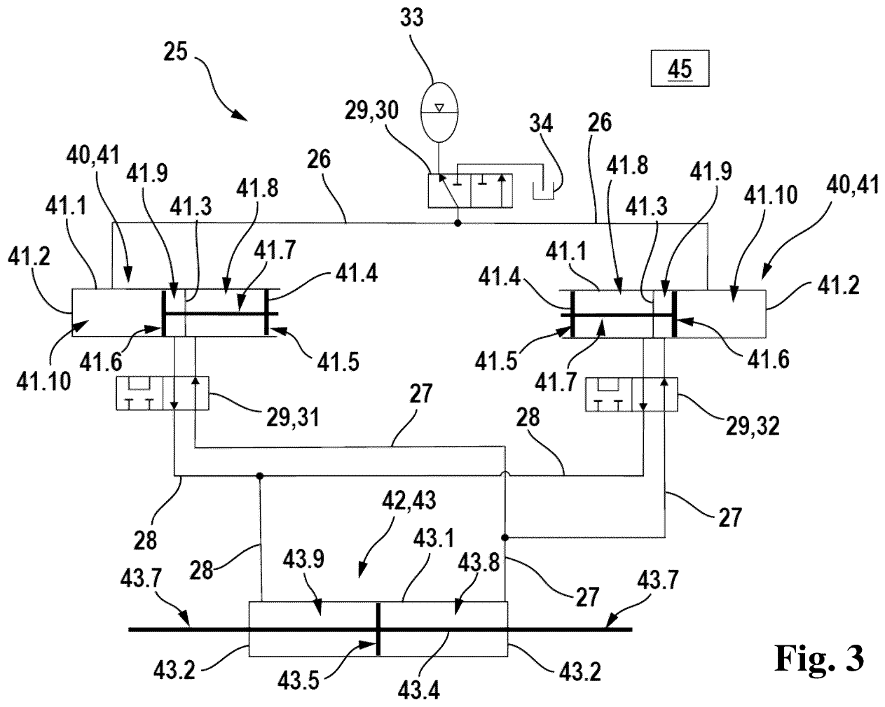

A drawbar element 16 is also arranged on the frame 11 which can be swiveled about a first or rear drawbar axis A running parallel to the vertical axis Z. The drawbar element 16 is connected to one of the steering knuckles of the front axis 14 via an articulated drawbar tie rod 22. Together with a drawbar unit 50, which will be explained below, the drawbar element 16 forms part of a connection system 5 via which the agricultural machine 10 can be connected to a towing vehicle 1. The agricultural machine 10 is operated in a deceleration steering mode during road travel if the agricultural machine 10 is being pulled by the towing vehicle 1. The steering cylinder of the front axis is switched passively and the steering of the front axis is completely determined by the deflection of the drawbar element 16 due to the forced coupling via the drawbar tie rod 22. At a rear end with respect to the longitudinal axis X, the drawbar element 16 has a trigger element 19 with two trigger fingers 20 projecting on both sides. Each trigger finger 20 is assigned to a trigger cylinder 41, which belongs to a trigger part 40 of a transmission device 25. The transmission device 25 is used to transmit steering movements of the front axis 14 to the rear axis 15 in a specific manner. Both trigger cylinders 41 are connected to the frame 11 so that they can swivel about vertically extending swivel axes of the trigger cylinder D. The steering cylinder of the rear axis 43 forms a steering part 42 of the transmission device 25. The trigger cylinders 41 and the steering cylinder of the rear axis 43 are hydraulically connected to each other in the deceleration steering mode, as can be seen from the diagram in FIG. 3. Each trigger cylinder 41 has a cylinder body 41.1, which has an end wall 41.2 at one end and also a division wall 41.3. The division wall 41.3 is traversed by a piston rod of the trigger cylinder 41.7 of a piston element 41.4.

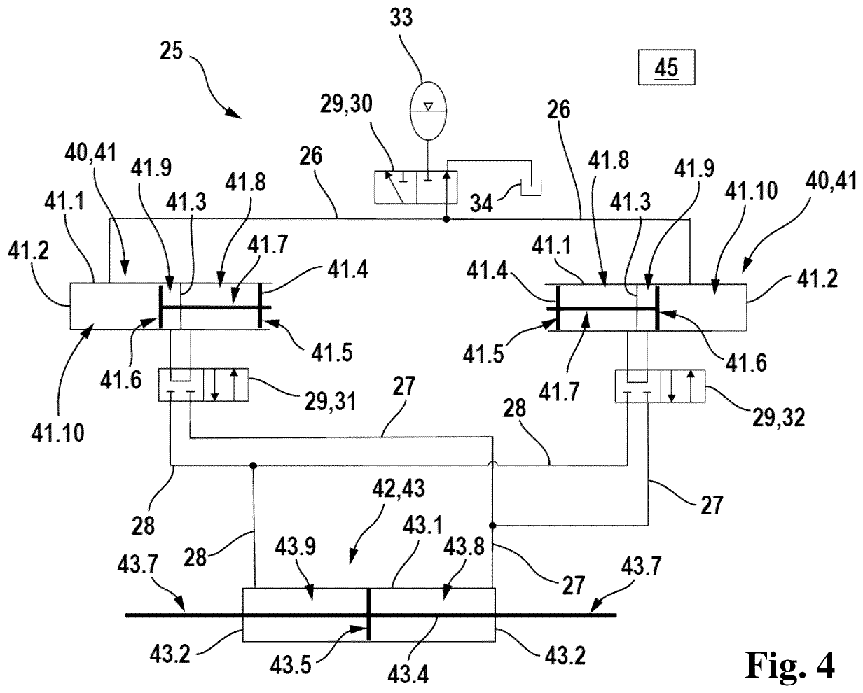

The piston element 41.4 also has two piston parts of the trigger cylinder 41.5, 41.6, which are rigidly connected by the piston rod of the trigger cylinder 41.7. A trigger cylinder's first chamber 41.8 is formed between the division wall 41.3 and the first piston part of the trigger cylinder 41.5, while a trigger cylinder's second chamber 41.9 is formed between the division wall 41.3 and the second piston part of the trigger cylinder 41.6. A trigger cylinder's third chamber 41.10 is formed between the end wall 41.2 and the second piston part of the trigger cylinder 41.6. The trigger cylinder's third chambers 41.10 are connected to a first hydraulic branch 26. In the deceleration steering mode, this is connected to a pressure accumulator 33 via a first valve 30 of a valve arrangement 29. This maintains an essentially constant hydraulic pressure in the trigger cylinder's third chambers 41.10. The trigger cylinder's first chamber 41.8 of the trigger cylinder 41 on the left in FIGS. 3 and 4 is connected to a second hydraulic branch 27 via a second valve 31, while the trigger cylinder's second chamber 41.9 is connected to a third hydraulic branch 28 via the second valve 31. The trigger cylinder's first chamber 41.8 of the trigger cylinder 41 on the right in FIGS. 3 and 4 is similarly connected to the third hydraulic branch 28 via a third valve 32, while the trigger cylinder's second chamber 41.9 is connected to the second hydraulic branch 27 via the third valve 32.

The steering cylinder of the rear axis 43 has a cylinder body 43.1 which is bounded on both sides by end walls 43.2. The above-mentioned piston rod of the steering cylinder 43.7 of a piston element 43.4 is passed through the end walls 43.2. The piston element 43.4 has a piston part of the steering cylinder 43.5 which is rigidly connected to the piston rod of the steering cylinder 43.7. A first chamber of the steering cylinder 43.8 and a second chamber of the steering cylinder 43.9 are defined between the latter and one of the end walls 43.2 in each case. The first chamber of the steering cylinder 43.8 is permanently connected to the second hydraulic branch 27, while the second chamber of the steering cylinder 43.9 is connected to the third hydraulic branch 28. If the piston element 41.4 of the left trigger cylinder 41 is deflected in the direction of the end wall 41.2, the volume of the trigger cylinder's second chamber 41.9 increases, while the volume of the trigger cylinder's first chamber 41.8 decreases. Hydraulic fluid is displaced via the second hydraulic branch 27, while hydraulic fluid flows in via the third hydraulic branch 28. The piston element 43.4 of the steering cylinder of the rear axis 43 is accordingly deflected to the left in relation to FIG. 3. In a corresponding manner, a deflection of the piston element 41.4 of the right trigger cylinder 41 in the direction of the end wall 41.2 causes the piston element 43.4 of the steering cylinder of the rear axis 43 to be deflected to the right. As long as there is no external deflection of one of the piston elements 41.4, these are held in a basic position due to the pressure in the trigger cylinder's third chamber 41.10, which can also be referred to as the basic position of the trigger cylinders 41. Due to the symmetrical design of the transmission device 25, this results in the steering cylinder of the rear axis 43 being held in a neutral position that corresponds to straight-ahead driving. This means that as long as none of the piston elements 41.4 of the trigger cylinder 41 is actively deflected, the rear axis 15 remains locked in a straight-ahead driving, which is particularly advantageous at high speeds.

Each of the trigger fingers 20 is designed to act on the piston element 41.4 of one of the trigger cylinders 41, or more precisely to apply force thereto on the side of the first piston part of the trigger cylinder 41.5. FIG. 1 shows a state in which an absolute amount of a front axis deflection of the front axis 14 is below a certain threshold value, which is typical in particular at high speeds, as the drawbar element 16 is usually only deflected slightly at these speeds. An amount of a steering angle of the front axis can, for example, be 8°, while the threshold value is 10°. Both trigger fingers 20 are not in contact with the trigger cylinders 41 which is why the rear axis 15 remains in its neutral position. FIG. 2 shows a state in which the absolute value of the front axis deflection is above the threshold value. The amount of the steering angle of the front axis can, for example, be 17°. One of the trigger fingers 20 contacts the trigger cylinder 41 assigned to it and thus acts on the piston element 41.4 thereof. As described above, this leads to a deflection of the piston element 43.4 of the steering cylinder of the rear axis 43, whereby the wheels 13 of the rear axis 15 are deflected in the opposite direction to the front axis 14 via the tie rods of the rear axis 24.

FIG. 4 shows the transmission device in single steering mode. The first hydraulic branch 26 is connected to an unpressurized tank 34 via the first valve 30. The trigger cylinder's first chamber 41.8 and the trigger cylinder's second chamber 41.9 of the left trigger cylinder 41 are additionally connected to each other via the second valve 31 and at the same time are fluidically separated from the second hydraulic branch 27 and the third hydraulic branch 28. In the same way, the trigger cylinder's first chamber 41.8 and the trigger cylinder's second chamber 41.9 of the right trigger cylinder 41 are connected to each other via the third valve 32 and at the same time are fluidically separated from the second hydraulic branch 27 and the third hydraulic branch 28. This means that the piston element 41.4 of each trigger cylinder 41 can be moved freely and there is no hydraulic power transmission to the steering cylinder of the rear axis 43. This can be pressurized via additional hydraulic lines (not shown in FIGS. 3 and 4) in order to deflect the rear axis 15 according to the situation. Switching between the deceleration steering mode and the single steering mode can be performed by the machine control unit 45, as can the control of the two axes 14, 15 in the single steering mode. According to an alternative not shown in the figures, each of the trigger cylinders 41 can be swiveled about the respective swivel axis of the trigger cylinder D so that it cannot be acted upon by the trigger element 19 in the single steering mode.

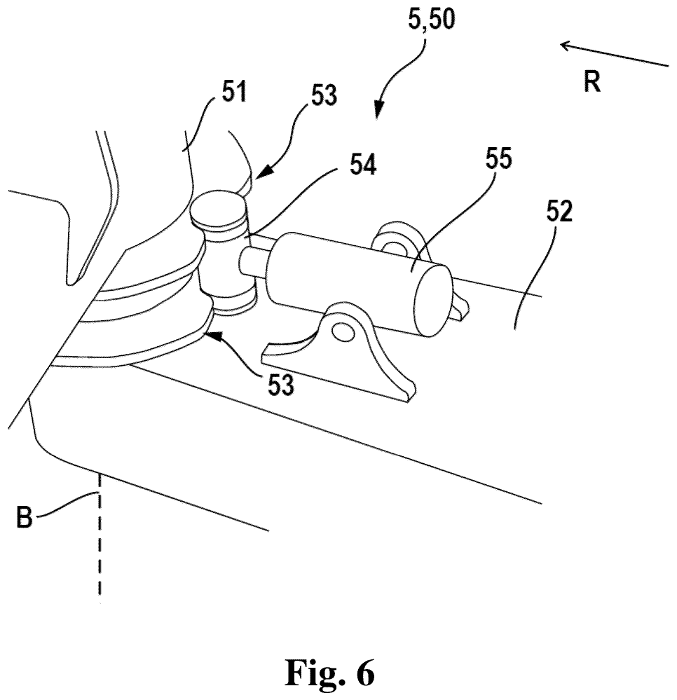

FIG. 5 shows that the agricultural machine 10 is connected to the towing vehicle 1 which can, for example, be a tractor, via the connection system 5 during road travel. A three-point hoist 3 is arranged on the vehicle body 2. The connection system 5 has a drawbar unit 50 as already mentioned. The connection system 5 is coupled to the three-point hoist 3 with a support part 51 and is supported thereon. A swivel part 52 is connected to the support part 51 so that it can swivel about a vertically extending second or front drawbar axis B. A drawbar boom 57 is connected to the swivel part 52 about a horizontally extending mounting axis C. As can be seen in the detailed view in FIG. 6, a locking cylinder 55 is arranged on the swivel part 52 via which a locking element 54 can be extended and retracted. FIG. 6 shows the locking element 54 in an extended position. The locking element 54 interacts with a curved track 53 which is fixed in position on the support part 51. The profile of the curved track 53 is designed so that extending the locking element 54 swivels the swivel part 52, including the drawbar boom 57 connected thereto, into a central position and holds it in this position. This can mean complete locking or elastic retention. In the latter case, although the swivel part 52 can be deflected from the center position to a limited extent by an external torque against a restoring torque, it is returned to the center position in the absence of the external torque. According to an alternative which is not shown, the swivel part 52 could also be actively swiveled about the front drawbar axis B via a corresponding actuator. The actuator could then be used to set any position, in particular the center position. The drawbar boom 57 is connected to the swivel part 52 by a setting cylinder 56 C. FIG. 5 shows the setting cylinder 56 in the extended position with the drawbar boom 57 aligned approximately horizontally in a towing position. The drawbar boom 57 can be swiveled into an approximately vertical mounting position by retracting the setting cylinder 56 (not shown). This can be set if the towing vehicle 1 is driving on a road without the agricultural machine 10. This also places the swivel part 52 in the center position and holds it there.

According to a variant which is not shown, the drawbar boom 57 can be swiveled relative to the support part 51 about a further swivel axis which can, for example, extend at an angle of 80° to 100°, in particular 90°, to the mounting axis C and which can, for example, also extend at an angle of between 70° and 100°, in particular 80° to 100°, to the horizontal plane at least in the towing position. The aforementioned swivel axis can in particular run parallel to the longitudinal axis of the drawbar boom 57, at least in the towing position. This could compensate for rotational relative movements around the longitudinal axis of the towing vehicle 1 and/or around the longitudinal axis X of the agricultural machine 10. In order to provide the swivel capability, the support part 51, the swivel part 52 and/or the drawbar boom 57 could be replaced by two parts that swivel against each other.

For road travel, the drawbar unit 50 can be coupled to the drawbar element 16 via interacting coupling elements 18, 58, 61. The drawbar unit 50 is decoupled and the agricultural machine 10 can perform the field processing when the agricultural machine has reached its operating position. A highly schematized attachment 8 shown in FIG. 5 can, for example, be used therefor which can, for example, also be coupled to the vehicle body 12 during road travel and which is arranged comparatively close above the drawbar boom 57.

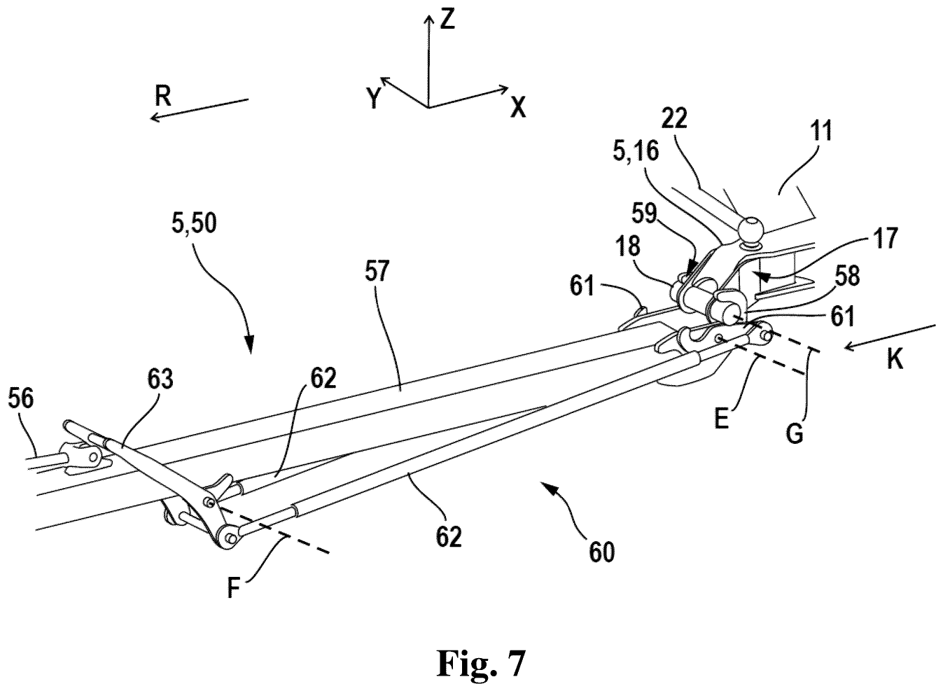

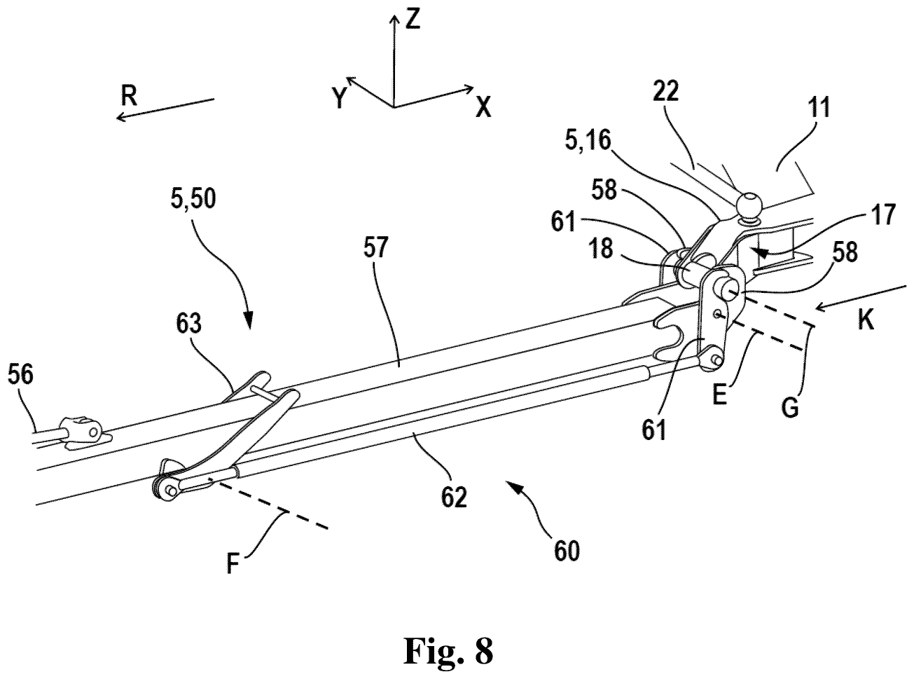

The coupling process is now explained with reference to FIGS. 7 and 8. A cylindrical first stop coupling element 18 is rigidly connected to the drawbar element 16. The drawbar boom 57 has two hook-like second stop coupling elements 58 at the ends which are designed to engage around the first stop coupling element 18 from behind if the drawbar boom 57 and the drawbar element 16 are arranged relative to one another in a coupling position shown in FIGS. 7 and 8. For coupling, the second stop coupling elements 58 are first moved behind the first stop coupling element 18. For this purpose, the drawbar boom 57 can first be swiveled slightly downwards relative to the horizontal via the setting cylinder 56 so that the second stop coupling elements 58 can be passed under the first stop coupling element 18 while the tractor unit 1 is reversing. The drawbar boom 57 is then swiveled into the horizontal position and the towing vehicle 1 can drive forward, with the drawbar boom 57 moving with the second stop coupling elements 58 relative to the drawbar element 16 along a coupling direction K, which in this case runs antiparallel to the longitudinal axis X. The width of the drawbar element 16 is matched to the lateral spacing of the second stop coupling elements 58 so that it is accommodated between the second stop coupling elements 58 with virtually no play in the coupling position. The width of the drawbar element 16 increases with respect to the transverse axis Y along the coupling direction K, with first guide surfaces 17 extending at an angle to the coupling direction K on both sides of the drawbar element 16 and cooperating with second guide surfaces 59 formed by the second stop coupling elements 58. A clearance defined between the guide surfaces 17, 59 decreases along the coupling direction until it is negligibly small in the coupling position. This provides a virtually complete form fit in relation to the transverse axis Y.

The coupling between the drawbar unit 50 and the drawbar element 16 is completed via a locking mechanism 60. Locking mechanism 60 has actuating coupling elements 61 arranged on both sides on the outside of the second stop coupling elements 58 which can be swiveled about a swivel axis of the coupling element E. They are connected via two coupling rods 62 to a rigid control lever 63, which in turn is connected to the drawbar boom 57 so that it can swivel about a swivel axis of the control lever F. Each coupling rod is rigid in itself and swivels on both sides. By swiveling the control lever 63, the actuating coupling elements 61 can be swiveled from a release position shown in FIG. 7 into a locking position shown in FIG. 8. In the locking position, the first stop coupling element 18 is enclosed between the second stop coupling elements 58 and the actuating coupling elements 61, i.e., there is a positive fit with respect to the longitudinal axis X, the transverse axis Y, and the vertical axis Z. The connection is in particular also torsion-proof with respect to the vertical axis Z, whereby swiveling movements on the part of the drawbar unit are transmitted directly to the drawbar element 16. The drawbar boom 57 and the drawbar element 16 are thus locked against each other in a translational and partially rotational manner. A rotational degree of freedom is, however, retained since the drawbar boom 57 can swivel relative to the drawbar element 16 about a swivel axis of the coupling G, which runs horizontally through the first stop coupling element 18. When the locking position of the actuating coupling elements 61 is reached, this can be registered on the side of the drawbar element 16 via a coupling sensor (not shown), whereupon the machine control unit 45 of the agricultural machine 10 can automatically switch from single steering mode to the deceleration steering mode intended for road travel.

As can be clearly seen in FIG. 5, the coupling rods 62 are so long that the control lever 63 is still arranged in front of the attachment 8 with respect to the longitudinal axis X. A user accordingly does not have to reach into the confined space below the attachment 8 to operate the control lever 63. The length of each coupling rod 62, i.e., the distance between its swivel points, is not the same as the distance between the swivel axis of the coupling element E and the swivel axis of the control lever F, but is slightly greater. As a result, swiveling of the control lever 63 is only possible with slight deformation of the components involved, whereby an unstable point exists between the position shown in FIG. 7 and the position shown in FIG. 8 which must be overcome by a corresponding torque. The control lever 63 returns from the unstable point to the nearest position without external forces. This provides that the locking mechanism 60 is guided into the locking position and that it does not leave this position again without significant external forces.

The connection system 5 can optionally have a camera 65 or another sensor via which a driver of the towing vehicle 1 can monitor the coupling process. The camera is shown strongly schematized in FIG. 5 via a dashed line, whereby it is exemplarily arranged on the drawbar boom 57 in the vicinity of the drawbar element 16. The camera could, for example, also be arranged on the swivel part 52, on the support part 51, or even on the drawbar element 16. A wireless image transmission to the towing vehicle 1 could take place in the latter case. In order to further facilitate the operation of the locking mechanism 60, the connection system 5 could have a control actuator 64 which is also shown dashed in FIG. 5 and which is attached to the drawbar boom 57 and to the control lever 63. It would in this case of course also be possible to redesign the locking mechanism 60 as a whole, whereby, for example, the long coupling rods 62 could be dispensed with. The control actuator 64 can advantageously be controlled from the tractor 1.

According to an alternative embodiment which is not here shown, the locking mechanism 60 can also have an actuating coupling element 61 which is designed as a latching element which, if approaching the coupling position, is first elastically deflected by the first stop coupling element 18 from a rest position corresponding to the locking position and returns to the rest position if the coupling position is reached, whereby it establishes a positive fit with the first stop coupling element 18.

A further alternative (which is also not shown) provides that the coupling direction K does not point forwards, but backwards in the direction of the longitudinal axis X, whereby the drawbar unit 50 can be brought into the coupling position by the towing vehicle 1 driving backwards towards the agricultural machine 10. Guide surfaces beveled with respect to the coupling direction K could in this case form a funnel through which the drawbar unit 50 with the at least one second stop coupling element 58 is guided automatically into the coupling position if reversing.

The present invention is not limited to embodiments described herein; reference should be had to the appended claims.

### LIST OF REFERENCE CHARACTERS

1 Towing vehicle
2 Vehicle body
3 Three-point hoist
4 Connection system
8 Attachment
10 Agricultural machine
11 Frame
12 Vehicle body
13 Wheel
14 Front axis
15 Rear axis
16 Drawbar element
17 First guide surface
18 First stop coupling element
19 Trigger element
20 Trigger finger
22 Drawbar tie rod
23 Tie rod of front axis
24 Tie rod of rear axis
25 Transmission device
26 First hydraulic branch
27 Second hydraulic branch
28 Third hydraulic branch
29 Valve arrangement
30 First valve
31 Second valve
32 Third valve
33 Pressure accumulator
34 Unpressurized tank
40 Trigger part
41 Trigger cylinder
41.1 Cylinder body
41.2 End wall
41.3 Division wall
41.4 Piston element
41.5 First piston part of the trigger cylinder
41.6 Second piston part of the trigger cylinder
41.7 Piston rod of the trigger cylinder
41.8 First chamber of trigger cylinder
41.9 Second chamber of trigger cylinder
41.10 Third chamber of trigger cylinder
42 Steering part
43 Steering cylinder of rear axis
43.1 Cylinder body
43.2 End wall
43.4 Piston element
43.5 Piston part of steering cylinder
43.7 Piston rod of steering cylinder
43.8 First chamber of steering cylinder
43.9 Second chamber of steering cylinder
45 Machine control unit
50 Drawbar unit
51 Support part
52 Swivel part
53 Curved track
54 Locking element
55 Locking cylinder
56 Setting cylinder
57 Drawbar boom
58 Second stop coupling element
59 Second guide surface
60 Locking mechanism
61 Actuating coupling elements
62 Coupling rod
63 Control lever
64 Control actuator
65 Camera
A Rear drawbar axis
B Front drawbar axis
C Mounting axis
D Swivel axis of trigger cylinder
E Swivel axis of coupling element
F Swivel axis of control lever
G Swivel axis of coupling
K Coupling direction
R Direction of travel
X Longitudinal axis
Y Transverse axis
Z Vertical axis

What is claimed is:

1-18. (canceled)

19: A connection system for connecting an agricultural machine to a towing vehicle, the connection system comprising:
a drawbar unit which comprises a support part for support on the towing vehicle and a drawbar boom, the drawbar boom being connected at least indirectly to the support part and being configured to swivel relative to the support part about a front drawbar axis; and
at least one coupling element which is arranged on the drawbar boom and which is configured to at least indirectly couple to the agricultural machine.

20: The connection system as recited in claim 19, wherein the drawbar boom is further configured to be swiveled about an at least partially horizontal mounting axis relative to the support part between a towing position and a mounting position.

21: The connection system as recited in claim 20, wherein the drawbar boom is actuatorically swiveled about the at least partially horizontal mounting axis relative to the support part between the towing position and the mounting position.

22: The connection system as recited in claim 20, wherein, the drawbar unit further comprises a swivel part which is connected to the support part, the swivel part being configured to swivel about the front drawbar axis, and the drawbar boom is connected to the swivel part so that the drawbar boom can swivel about the at least partially horizontal mounting axis.

23: The connection system as recited in claim 19, further comprising:
a drawbar element which is configured to at least indirectly connect to a frame of the agricultural machine and to swivel about a rear drawbar axis,
wherein,
the at least one coupling element comprises coupling elements which correspond to one another,
the coupling elements which correspond to one another are arranged on the drawbar boom and on the drawbar element to couple the drawbar boom and the drawbar element at least translationally in a locking position when the coupling elements are arranged in a coupling position relative to one another, and
at least one of the coupling elements is configured to be adjustable into a release position to release the drawbar boom from the drawbar element.

24: The connection system as recited in claim 23, wherein the coupling elements comprise,
least one first stop coupling element which is rigidly connected to the drawbar element,
at least one second stop coupling element which is rigidly connected to the drawbar boom and which forms a positive fit with the at least one first coupling element in the coupling position, and
at least one actuating coupling element which is configured to be adjustable between the locking position and the release position.

25: The connection system as recited in claim 24, wherein,
the at least one actuating coupling element is further configured to be adjustably connected to the drawbar boom, and
in the locking position, the at least one first stop coupling element is positively received between the at least one actuating coupling element and the at least one second stop coupling element.

26: The connection system as recited in claim 25, wherein,
the drawbar boom and the drawbar element are configured to be guided into the coupling position in an at least partially horizontal coupling direction, and
the at least one first stop coupling element and the at least one second stop coupling element are configured to form the positive fit in the coupling position at least in the at least partially horizontal coupling direction.

27: The connection system as recited in claim 26, further comprising:
first guide surfaces which are arranged to be stationary relative to the drawbar element; and
second guide surfaces which are arranged to be stationary relative to the drawbar boom,
wherein,
the first guide surfaces and the second guide surfaces together define a space which is transverse to the at least partially horizontal coupling direction, and
at least one of the first guide surfaces and the second guide surfaces are beveled at least in some regions relative to the at least partially horizontal coupling direction so that a clearance is reduced as the coupling position is approached.

28: The connection system as recited in claim 27, further comprising:
a locking mechanism which is arranged on the drawbar boom,
wherein,
the locking mechanism comprises the at least one actuating coupling element, and,
the at least one actuating coupling element is further configured to be remotely operated via the locking mechanism.

29: The connection system as recited in claim 28, wherein the locking mechanism comprises a control lever which is arranged,
in a swiveled manner on the drawbar boom,
at a distance from the at least one actuating coupling element, and
so as to be connected to the at least one actuating coupling element in a force-transmitting manner.

30: The connection system as recited in claim 29, further comprising:
at least one coupling rod,
wherein,
the control lever is connected to the at least one actuating coupling element in the force-transmitting manner via the at least one coupling rod.

31: The connection system as recited in claim 28, wherein the at least one actuating coupling element is further configured to be actuatorically adjustable via the locking mechanism.

32: The connection system as recited in claim 24, wherein the at least one actuating coupling element is provided as a latching element which is configured to be deflected elastically out of the locking position against a restoring force when approaching the coupling position, and to return to the locking position following the restoring force when the coupling position is reached.

33: The connection system as recited in claim 23, wherein the drawbar boom is further configured to be retained in a central position relative to the front drawbar axis relative to the support part.

34: The connection system as recited in claim 33, further comprising:
an actuator which is configured to at least one of guide the drawbar boom into the central position and to retain the drawbar boom in the central position.

35: The connection system as recited in claim 23, further comprising:
at least one monitoring sensor which is configured to monitor an approach to the coupling position.

36: The connection system as recited in claim 35, wherein the at least one monitoring sensor is a camera.

37: The connection system as recited in claim 23, further comprising:
at least one coupling sensor which is configured to detect that the locking position has been reached and to send a locking signal to a machine control unit of the agricultural machine.

38: The connection system as recited in claim 37, further comprising:
the agricultural machine,
wherein,
the machine control unit of the agricultural machine is configured to switch to a mode for a road travel if the locking signal is received.

39: A method for connecting an agricultural machine to a towing vehicle, the method comprising:
providing a drawbar unit which comprises a support part for support on the towing vehicle and a drawbar boom, the drawbar boom being connected at least indirectly to the support part and being configured to swivel relative to the support part about a front drawbar axis;
providing at least one coupling element which is arranged on the drawbar boom, the at least one coupling element being configured to at least indirectly couple to the agricultural machine; and
connecting the drawbar boom to the agricultural machine via the at least one coupling element.

40: The method as recited in claim 39, wherein,
the drawbar element is connected at least indirectly to a frame of the agricultural machine so as to swivel about a rear drawbar axis,
the at least one coupling element comprises coupling elements which correspond to one another, and
the coupling elements which correspond to one another are arranged on the drawbar boom and on the drawbar element to couple the drawbar boom and the drawbar element at least translationally in a coupling position relative to one another via the coupling elements,
the method further comprising:
displacing at least one of the coupling elements from a release position which releases the drawbar boom from the drawbar element to a locking position.
